(19) United States
(12) Patent Application Publication
(10) Pub. No.: US 2018/0023339 A1
(43) Pub. Date: Jan. 25, 2018

(54) CORDLESS WINDOW COVERING

(71) Applicant: GUANGZHOU GARDEN RUBBER & PLASTIC CO., LTD., Guangzhou (CN)

(72) Inventors: Chou Ho SUNG, Guangzhou (CN); Dick CHEN, Guangzhou (CN); Bensheng LIU, Guangzhou (CN)

(73) Assignee: GUANGZHOU GARDEN RUBBER & PLASTIC CO., LTD., Guangzhou (CN)

(21) Appl. No.: 15/693,438

(22) Filed: Aug. 31, 2017

Related U.S. Application Data
(63) Continuation-in-part of application No. 14/929,900, filed on Nov. 2, 2015, now abandoned.

(30) Foreign Application Priority Data
Jun. 5, 2015 (CN) 201510307104.1
Jun. 5, 2015 (CN) 201520383794.4

(51) Int. Cl. E06B 9/322

(52) U.S. Cl. CPC E06B 9/322; E06B 2009/3222

(57) ABSTRACT

A cordless window covering for simplifying the winding manner of a pull cord includes a movable part, a telescopic part, a pull cord fixing seat, a pull cord and a guide rail. The telescopic part has one end fixedly connected to the external environment, and another end connected to the movable part, and the movable part is movable leftward and rightward along with the telescopic part. The pull cord fixing seat is configured to be fixedly connected to the external environment. The movable part is provided with at least one first transverse column arranged transversely, the pull cord fixing seat is provided with at least one second transverse column arranged transversely, and the movable part has a protruding portion in direct contact with the inner wall of the guide rail.

### CROSS-REFERENCE TO RELATED APPLICATIONS

This application is a Continuation-In-Part of U.S. patent application Ser. No. 14/929,900 which claims the benefit of priorities to Chinese Patent Application No. 201510307104.1 and No. 201520383794.4 both titled “CORDLESS WINDOW COVERING” and filed with the Chinese State Intellectual Property Office on Jun. 5, 2015, the entire disclosures of which are incorporated herein by reference.

### TECHNICAL FIELD

The present application relates to the technical field of window coverings, and in particular to a cordless window covering.

### BACKGROUND

Currently, there are various forms of window covering, which can be classified into a corded type and a cordless type according to the manner of adjusting the height of the window covering. For the cordless type, a bottom of the window covering is applied with a force upward or downward by hand, to stretch or fold the window covering.

A cordless window covering mainly includes a window covering body, a transmission set and a pull cord. The transmission set is located at the top of the window covering body and is connected to the pull cord, and the window covering body is connected to the pull cord via the transmission set. The transmission set generally includes a spring device configured to be connected to the pull cord, and the pull cord is reeled up or released by the extension or contraction of the spring device, thereby moving the window covering body upward or downward.

The disadvantage of the existing cordless window covering is that the manner of winding the pull cord around the transmission set is complicated, and the window covering body cannot stay stably in any position.

### SUMMARY

A cordless window covering is provided according to the present application, to simplify the winding manner of a pull cord.

The technical solution of a cordless window covering according to embodiments of the present application is described as follows. A cordless window covering includes a movable part, a telescopic part, a pull cord fixing seat and a pull cord and a guide rail; the telescopic part has one end configured to be fixedly connected to a window, and another end configured to be connected to the movable part, and the movable part is movable leftward and rightward along with the telescopic part; the pull cord fixing seat is configured to be fixedly connected to the window; the guide rail has a cavity and a sliding groove is provided in the cavity; and the movable part is provided with at least one first transverse column arranged transversely for winding the pull rod, the pull cord fixing seat is provided with at least one second transverse column arranged transversely for winding the pull rod, and the pull cord passing through a window covering body is configured to be fixed to the movable part or the pull cord fixing seat after winding around the first transverse column and the second transverse column; and wherein, the movable part is provided with at least one first spacer, and the first transverse column is arranged on the at least one first spacer transversely, and the at least one first spacer separates the first transverse column along an axial direction of the first transverse column into a plurality of independent sub-areas for winding the pull cord; and wherein, two side walls of the movable part are each provided with a fitting portion in direct contact with an inner wall of the guide rail, and the fitting portion of the movable part is configured to be guided by the sliding grove to allow the movable part to be movable leftward and rightward in the guide rail.

Optionally, the inner wall at a first side of the cavity of the guide rail is provided with a first upper guiding portion and a first lower guiding portion both extending from the inner wall at the first side into the cavity; the inner wall at a second side, opposite to the first side, of the cavity of the guide rail is provided with a second upper guiding portion and a second lower guiding portion both extending from the inner wall at the second side into the cavity; and the sliding groove is formed by the first upper guiding portion, the first lower guiding portion, the second upper guiding portion and the second lower guiding portion; and the fitting portion includes a first upper protruding portion and a first lower protruding portion both extending outward from a first side wall of the movable part, and a second upper protruding portion and a second lower protruding portion both extending outward from a second side wall of the movable part, and the second side wall of the movable part is opposite to the first side wall of the movable part; and wherein, the first upper protruding portion and the first lower protruding portion are in direct contact with the inner wall at the first side of the cavity, the second upper protruding portion and the second lower protruding portion are in direct contact with the inner wall at the second side of the cavity, to allow the movable part to be guided by the first upper guiding portion, the first lower guiding portion, the second upper guiding portion and the second lower guiding portion to move leftward and rightward along the guide rail.

Optionally, the movable part includes a body and a cover detachably connected to the body; the first upper protruding portion and the second upper protruding portion are respectively two protruding edges extending outward from two transverse side walls of the cover, and the first lower protruding portion and the second lower protruding portion are respectively two protruding edges extending outward from two transverse side walls of the body.

Optionally, each of the at least one first spacer has a first part located at the cover and a second part located at the body; and when the body and the cover are assembled, the first part and the second part cooperate with each other to define a space for accommodating the first transverse column.

Optionally, the first transverse column is provided with a plurality of pulleys for winding the pull cord located in the plurality of independent sub-areas of the first transverse column respectively.

Optionally, the inner wall at a first side of the cavity of the guide rail is provided with a first upper guiding portion and a first lower guiding portion both extending from the inner wall at the first side into the cavity; the inner wall at a second side, opposite to the first side, of the cavity of the guide rail is provided with a second upper guiding portion and a second lower guiding portion both extending from the inner wall at the second side into the cavity; and the sliding groove is formed by the first upper guiding portion, the first lower guiding portion, the second upper guiding portion and the second lower guiding portion; and the fitting portion includes a first side wall of the movable part, and a second side wall of the movable part which is opposite to the first side wall of the movable part; and wherein, the first side wall is in direct contact with the inner wall at the first side of the cavity, the second side wall is in direct contact with the inner wall at the second side of the cavity, to allow the movable part to be guided by the first upper guiding portion, the first lower guiding portion, the second upper guiding portion and the second lower guiding portion to move leftward and rightward along the guide rail.

Optionally, the pull cord fixing seat is provided with at least one second spacer, and the second transverse column is arranged on the at least one spacer transversely, and the at least one second spacer separates the second transverse column along an axial direction of the second transverse column into a plurality of independent sub-areas for winding the pull cord.

Optionally, the pull cord fixing seat has a body, and the at least one second spacer is fixedly provided at a first side of the body; a first opening is provided at a second side of the body, which is opposite to the first side of the body, to allow the at least one second transverse column to be installed via the first opening; a side wall of the first opening has a protrusion; and in a case that the at least one second transverse column is installed in place, the protrusion is configured to retain the at least one second transverse column.

Optionally, the pull cord fixing seat further has a cover detachably connected to the body; and in a case that the at least one second transverse column is installed in place, the cover is fixedly connected to the body, to close the first opening.

Optionally, wherein a steering transverse column is further provided on the pull cord fixing seat, the pull cord passing through the window covering body is configured to wind around the first transverse column and the second transverse column after winding around the steering transverse column.

Optionally, the second side of the body of the pull cord fixing seat further has a second opening, to allow the steering transverse column to be installed via the second opening; a side wall of the second opening has a protrusion; and in a case that the steering transverse column is installed in place, the protrusion is configured to retain the steering transverse column.

Optionally, the pull cord fixing seat is provided with at least one second spacer, and the second transverse column is arranged on the at least one spacer transversely, and the at least one second spacer separates the second transverse column along an axial direction of the second transverse column into a plurality of independent sub-areas for winding the pull cord.

Optionally, the pull cord fixing seat has a body, and the at least one second spacer is fixedly provided at a first side of the body of the pull cord fixing seat; a first opening is provided at a second side of the body of the pull cord fixing seat, which is opposite to the first side of the body of the pull cord fixing seat, to allow the at least one second transverse column to be installed via the first opening; a side wall of the first opening has a protrusion; and in a case that the at least one second transverse column is installed in place, the protrusion is configured to retain the at least one second transverse column.

Optionally, a plurality of second spacers are provided on the pull cord fixing seat, and the plurality of second spacers are arranged in at least one row and are in parallel with each other in each row, and each row of the second spacers has one of the second transverse column passing through the second spacers in this row.

Optionally, the second transverse column is provided with a plurality of pulleys for winding the pull cord located in the plurality of independent sub-areas of the second transverse column respectively.

Optionally, the cordless window covering further includes a telescopic part fixing seat, wherein the telescopic part fixing seat is fixed on the guide rail, and an end of the telescopic part is mounted on the telescopic part fixing seat.

Optionally, the pull cord fixing seat is fixed on the guide rail.

Optionally, the cordless window covering further includes a transmission shaft, a winder configured to be sleeved on the transmission shaft, a controller configured to be connected to an end of the transmission shaft and drive the transmission shaft to rotate, a handle configured to be connected to the controller and drive the controller to rotate, and a ladder tape configured to pass through the window covering body and to be fixed on the winder.

Optionally, the cordless window covering further includes a winder mounting seat, wherein the winder mounting seat is fixed on the guide rail, and the winder is arranged on the winder mounting seat.

Optionally, a retaining groove is provided on the winder mounting seat and is configured for accommodating the winder.

With the above technical solution, the pull cord passes through the window covering body and then winds around the first transverse column and the second transverse column, the movable part is slidable back and forth by pulling the window covering body downward or pushing the window covering body upward. When pulling the window covering body downward, the pull cord being pulled downward pulls the movable part and in turn stretches the telescopic part. When pushing the window covering body upward, the telescopic part tends to return to its original state due to an elastic restoring force, thus pulling the pull cord in an opposite direction, that is, pulling the pull cord upward. The fitting portion of the movable part is in direct contact with the inner wall of the guide rail, which increases the friction force, and thus, when a user stops operating the cordless window covering and wishes the window covering body to be fixed at a certain position, the cordless window covering is overall in a state of force equilibrium, therefore, the window covering body can stably stay at this position and the operation of the cordless window covering is stable and reliable.

Secondly, a steering transverse column is also provided on the pull cord fixing seat, the pull cord passing through the window covering body first winds around the steering transverse column and then winds around the first transverse column and the second transverse column, the pull cord passing through the window covering body first winds around the steering transverse column, thus can wind around the first transverse column and the second transverse column in substantially a horizontal direction, thereby saving effort in pulling the pull cord.

Thirdly, each of the movable part and the pull cord fixing seat can be provided with at least one spacer, the spacers are configured separate the first transverse column and the second transverse column into several independent sub-areas, respectively. The pull cord is wound in the several independent sub-areas, and since the pull cords are wound around the first transverse column and the second transvers post, the pull cords winding around the first transverse column and the second transverse column are linked, thus the pull cord can be wound in any way without considering the winding manner of the pull cord, thus the winding is simple.

### BRIEF DESCRIPTION OF THE DRAWINGS

For more clearly illustrating embodiments of the present application or the technical solution in the conventional technology, drawings referred to describe the embodiments or the conventional technology will be briefly described hereinafter. Apparently, the drawings in the following description are only several embodiments of the present application, and for the person skilled in the art other drawings may be obtained based on these drawings without any creative efforts.

FIG. 1 is a schematic view showing the overall structure of a cordless window covering according to an embodiment of the present application;

FIG. 2 is a schematic view showing the internal structure of the cordless window covering according to the embodiment of the present application;

FIG. 3 is a schematic view showing the structure of a movable part of the cordless window covering according to the embodiment of FIG. 1;

FIG. 4 is a schematic view showing the structure of a pull cord fixing seat of the cordless window covering according to the embodiment of FIG. 1;

FIG. 5 is another schematic view showing the structure of a cordless window covering according to an embodiment of the present application;

FIG. 6 is a structural view showing the cordless window covering according to the embodiment of FIG. 5 controlling a window covering body to be retracted and unfolded;

FIG. 7 is a schematic view showing the structure of a pull cord fixing seat with a spacer of the cordless window covering according to the embodiment of FIG. 5;

FIG. 8 is a schematic view showing the structure of a pull cord fixing seat without a spacer of the cordless window covering according to the embodiment of FIG. 5;

FIG. 9 is a schematic view showing the structure of a movable part of the cordless window covering according to the embodiment of FIG. 5;

FIG. 10 is a schematic view showing the structure of a telescopic part fixing seat of the cordless window covering according to the embodiment of FIG. 5;

FIG. 11 is a schematic view showing the internal structure of the cordless window covering according to an embodiment of the present application;

FIG. 12 is a schematic view showing the structure of a movable part of the cordless window covering according to the embodiment of FIG. 11;

FIG. 13 is a schematic view showing the cooperation between the movable part and the guide rail;

FIG. 14 is an exploded view of an embodiment of a pull cord fixing seat of the cordless window covering according to the embodiment of FIG. 11;

FIG. 15 is an exploded view of the embodiment of the pull cord fixing seat in FIG. 14 viewed in another direction;

FIG. 16 is an exploded view of another embodiment of a pull cord fixing seat of the cordless window covering according to the embodiment of FIG. 11;

FIG. 17 is an exploded view of the embodiment of the pull cord fixing seat in FIG. 16 viewed in another direction;

FIG. 18 is an exploded view of yet another embodiment of a pull cord fixing seat of the cordless window covering according to the embodiment of FIG. 11;

FIG. 19 is an exploded view of the embodiment of the pull cord fixing seat in FIG. 18 viewed in another direction;

FIG. 20 is a schematic sectional view of the pull cord fixing seat in FIG. 18;

FIG. 21 is a schematic view showing the internal structure of the cordless window covering according to an embodiment of the present application.

Reference numerals in the above Figures:

| | | | |
|---|---|---|---|
| 1 | telescopic part fixing seat, | 2 | controller, |
| 3 | winder fixing seat, | 4 | transmission shaft, |
| 5 | pull cord, | 6 | movable par, |
| 7 | pull cord fixing seat, | 8 | telescopic part, |
| 9 | guide rail, | 10 | winder, |
| 11 | window covering body, | 12 | upper rail, |
| 13 | lower rail. | | |

### DETAILED DESCRIPTION

A cordless window covering is provided according to the present application, to simplify the winding manner of a pull cord, and to make the window covering body to stay at any position stably.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

### First Embodiment

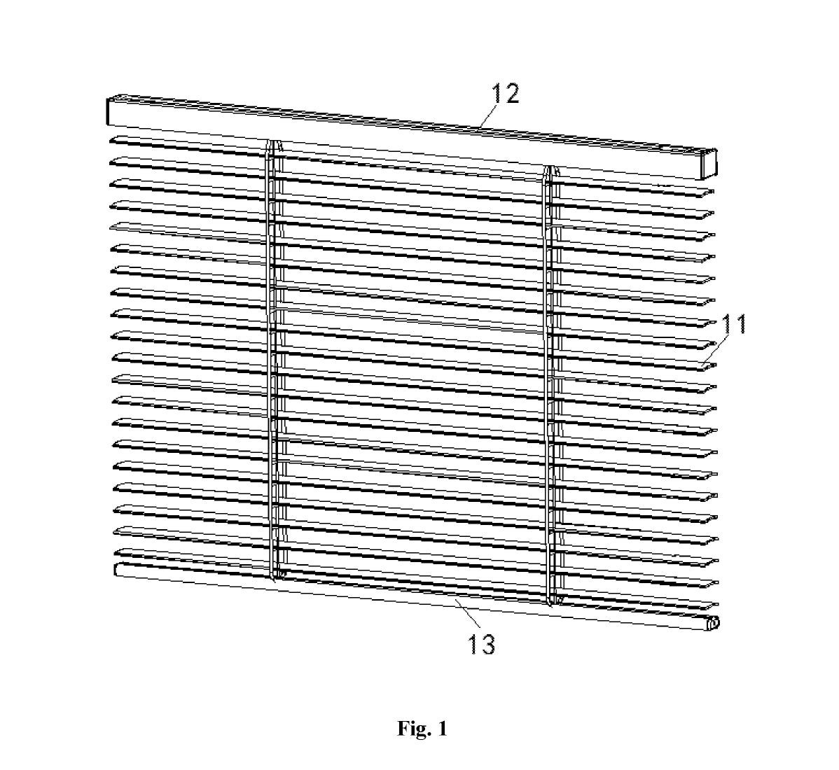

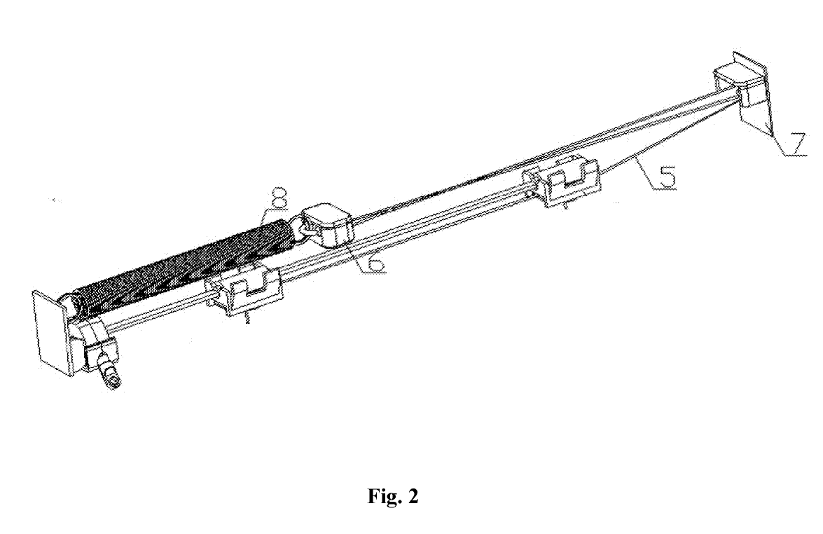

Referring to FIGS. 1 to 4, the technical solution of a cordless window covering according to an embodiment of the present application is described as follows. The cordless window covering includes a movable part 6, a telescopic part 8, a pull cord fixing seat 7 and a pull cord 5. The telescopic part 8 has one fixed end which may be fixedly connected to the external environment, and another end connected to the movable part 6. The movable part 6 is movable leftward and rightward with stretch and compression of the telescopic part 8, and the pull cord fixing seat 7 is configured to be connected to the external environment. The external environment can be a wall, a window, a window frame or the like.

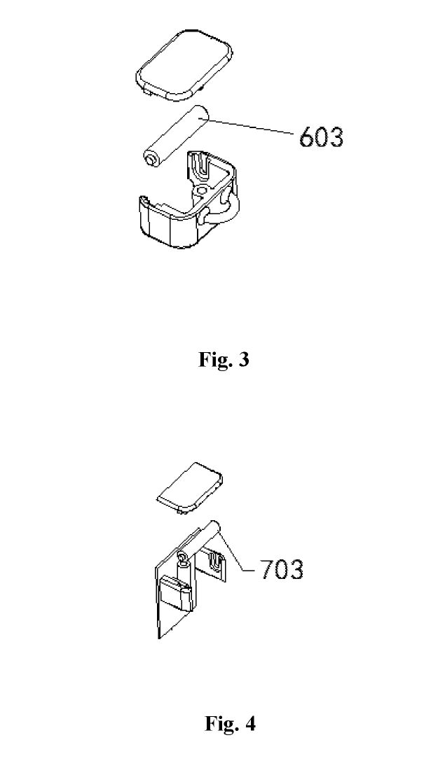

As shown in FIGS. 3 and 4, the movable part 6 is provided with a first transverse column 603 around which the pull cord 5 can be wound, and the pull cord fixing seat 7 is provided with a second transverse column 703 around which the pull cord 5 can be wound.

Taking the cordless window covering in use as an example, arranging in a transverse direction refers to arranging in a horizontal direction, each of the first transverse column 603 and the second transverse column 703 is arranged transversely, and the pull cord 5 passing through the window covering body 11 is fixed on the movable part 6 or the pull cord fixing seat 7 after winding around the first transverse column 603 and the second transverse column 703.

It is to be noted that, in this embodiment, the movable part 6, the telescopic part 8 and the pull cord fixing seat 7 can be located inside an upper rail 12 of the window covering body 11, and can also be located inside a lower rail 13 of the window covering body 11, the specific positions for mounting the above parts are not limited as long as the opening or closing of the window covering body 11 can be achieved.

It is to be noted that, in this embodiment, the telescopic part 8 is generally pre-stretched by a certain distance when the window covering body 11 is retracted completely. When the telescopic part 8 is stretched by a certain distance, the telescopic part 8 is in a stretched state, and the pull cord 5 is in a tightened state, which saves effort in pulling the window covering body 11 downward or pushing the window covering body 11 upward.

With the above technical solution, the pull cord 5 passes through the window covering body 11 and then winds around the first transverse column 603 and the second transverse column 703, the movable part 6 is slidable back and forth by pulling the window covering body 11 downward or pushing the window covering body 11 upward. When pulling the window covering body 11 downward, the pull cord 5 being pulled downward pulls the movable part 6 and in turn stretches the telescopic part 8. When pushing the window covering body 11 upward, the telescopic part 8 tends to return to its original state due to an elastic restoring force, thus pulling the pull cord 5 in an opposite direction, that is pulling the pull cord 5 upward; when the window covering body 11 is fixed at a certain position, the cordless window covering is overall in a state of force equilibrium, therefore, the winding manner is simple.

### Second Embodiment

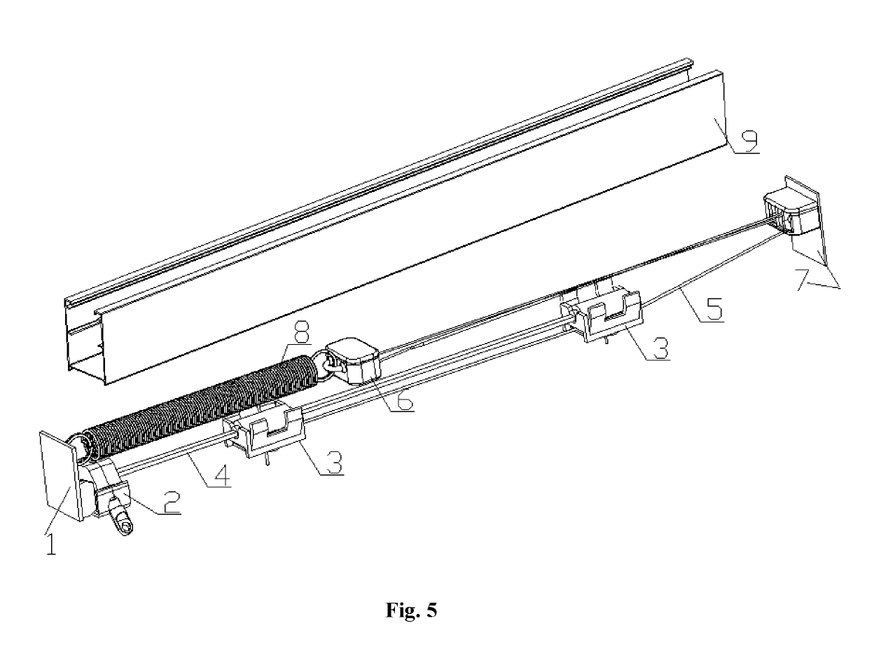

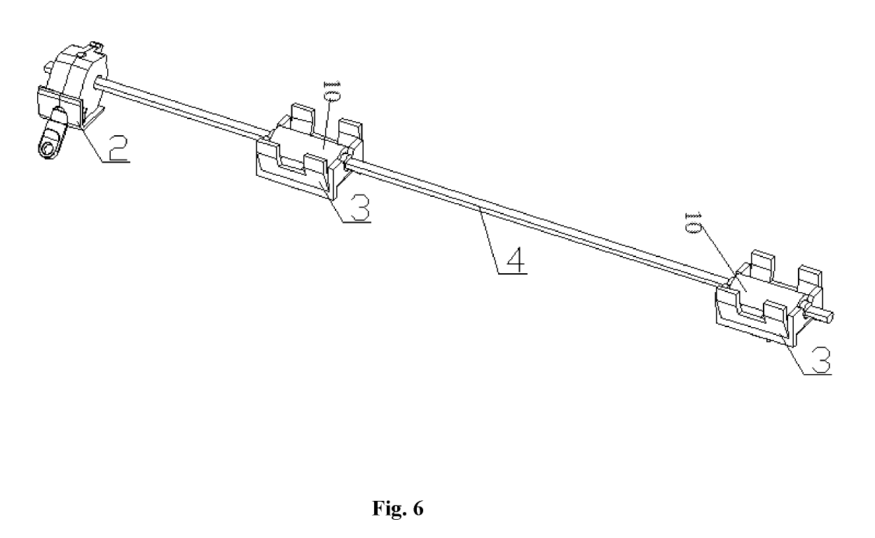

Referring to FIGS. 5 to 21, a cordless window covering is provided according to an embodiment of the present application. The cordless window covering is fixedly connected to the external environment, and the technical solution of the cordless window covering is described as follows. The cordless window covering mainly includes a guide rail 9, a movable part 6, a telescopic part 8, and a pull cord fixing seat 7 fixed at the guide rail 9. A sliding groove configured to allow the movable part 6 to slide leftward and rightward is provided in the guide rail 9. The pull cord fixing seat 7 can be fixed at any position of the guide rail 9, and is not limited to be fixed at an outermost end of the guide rail 9 as shown in FIG. 5.

The telescopic part 8 has one end connected to the guide rail 9 and another end connected to the movable part 6. In this embodiment, since one end of the telescopic part 8 is connected to the guide rail 9, the cordless window covering may further include a telescopic part fixing seat 1, the telescopic part fixing seat 1 can be fixed at any position of the guide rail 9, and is not limited to be fixed at the outermost end of the guide rail 9 as shown in FIG. 5.

One end of the telescopic part 8 is connected to the telescopic part fixing seat 1, it could be further noted that, as shown in FIG. 10, a circular ring can be provided on the telescopic part fixing seat 1, one end of the telescopic part 8, such as a spring, is linked with the circular ring to connect the telescopic part 8 to the telescopic part fixing seat 1.

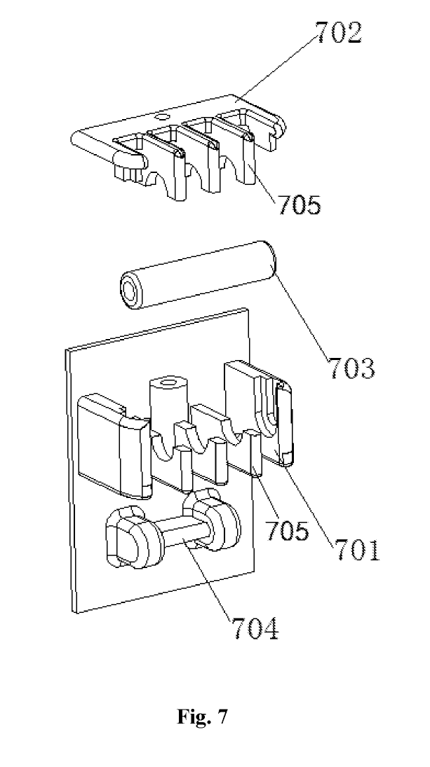

As shown in FIGS. 7 to 9 and 11 to 21, the movable part 6 is provided with a first transverse column 603 around which the pull cord 5 can be wound, and the pull cord fixing seat 7 is provided with a second transverse column 703 around which the pull cord 5 can be wound. It is to be noted that, in this embodiment, the number of each of the first transverse column 603 and the second transverse column 703 may be one as shown in the Figures, however, the number of each of the first transverse column 603 and the second transverse column 703 is not limited to one as shown in the Figures, and can also be set according to practical situation, and the number of each of the first transverse column 603 and the second transverse column 703 can also be more than two (including two).

With the above technical solution, the pull cord 5 passes through the window covering body (the window covering body 11 as shown in FIG. 1) and winds around the first transverse column 603 and the second transverse column 703, the movable part 6 can be pulled downward by the pull cord 5 to slide in the sliding groove of the guide rail 9, and the telescopic part 8 can be stretched to move the window covering body downward. By pushing the lower rail (the lower rail 13 as shown in FIG. 1, the lower rail is located at the very bottom of the window covering body) of the window covering body upward, the telescopic part 8 pulls the pull cord in the opposite direction due to an elastic restoring force, to move the window covering body upward. In the process of the upward and downward movement of the window covering body, the pull cord 5 winds around the first transverse column 603 of the movable part 6 and the second transverse column 703 of the pull cord fixing seat 7 back and forth.

As shown in FIGS. 5 to 21, the cordless window covering is chosen according to the specific size of usage occasion, when the external environment is relatively small, the guide rail 9 of the cordless window covering can not be oversized, therefore, in order to facilitate adjusting the length of the window covering body within a wide range, the movable part 6 can be provided with several (several means at least one) first spacers 604, and the pull cord fixing seat 7 can be provided with several (several means at least one) second spacers 705, and the first spacers 604 and the second spacers 705 can separate the first transverse column 603 and the second transverse column 703 into several independent sub-areas, respectively, and thus the pull cord 5 can be divided into several independent sub-areas by the first spacers 604 and the second spacers 705, and the pull cord 5 can wind around back and forth in the several independent sub-areas. By using the technical solution, the more the number of turns of the pull cord 5 winding around back and forth, the longer the length of the pull cord 5 on the window covering body, and the pull cords 5 in the several independent sub-areas will not interfere with each other, thereby avoiding kinking. Moreover, since the pull cords 5 are winding around the first transverse column 603 and the second transverse column 703, the pull cords 5 winding around the first transverse column 603 and the second transverse column 703 are linked, thus will not be applied with different forces when winding around the different independent sub-areas, thus the pull cord 5 can be wound in the several independent sub-areas in any manner without considering the winding manner of the pull cord 5. Furthermore, the number of each of the first transverse column 603 and the second transverse column 703 is reduced by providing the first spacers 604 and the second spacers 705, thus the structure is simple.

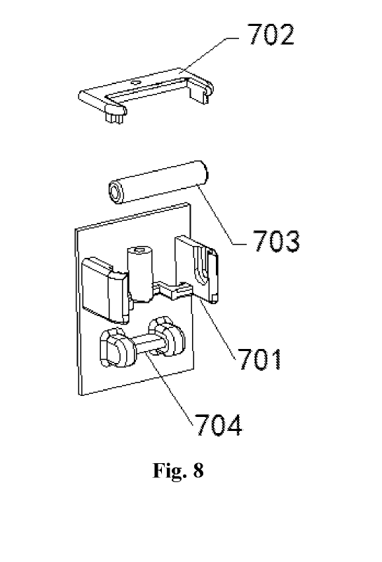

It is further noted that, as shown in FIGS. 7 and 8, a steering transverse column 704 may also be provided on the pull cord fixing seat 7. The steering transverse column 704 is located below the second transverse column 703, and the steering transverse column 704 and the position where the pull cord 5 is located after passing through the window covering body are substantially in one horizontal plane. The pull cord 5 passing through the window covering body first winds around the steering transverse column 704 and then winds around the first transverse column 603 and the second transverse column 703 back and forth, thereby avoiding the pull cord 5 from titling at a certain angle when the pull cord 5 directly winds around the first transverse column 603 and the second transverse column 703. After passing through the steering transverse column 704, the pull cord 5 winds around the first transverse column 603 and the second transverse column 703 back and forth in a substantially horizontal direction, thereby saving effort in pulling the pull cord 5.

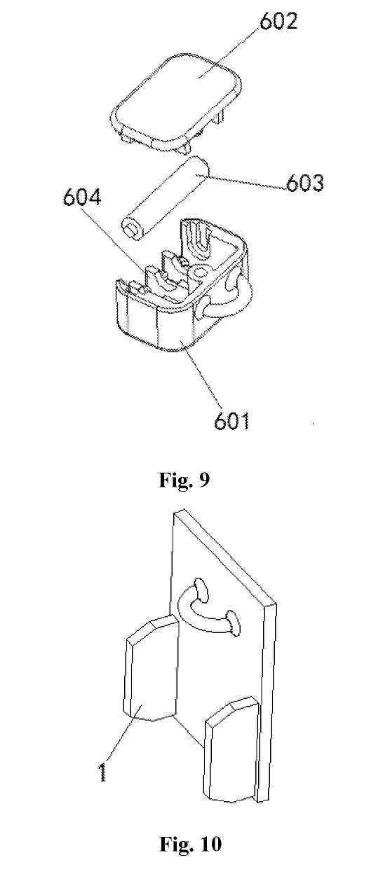

It is further noted that, as shown in FIG. 9, the end of the movable part 6 that is connected to the telescopic part 8 may be provided with a circular ring, the telescopic part 8, such as a spring, is linked with the circular ring on the outer surface of the movable part 6 to be connected to the movable part 6. The movable part 6 may include a main body 601 and a cover plate 602 located on the main body 601. Several (more than or equal to one) first spacers 604 are provided between the main body 601 and the cover plate 602, a through hole configured to allow the first transverse column 603 to pass through is provided in each first spacer 604, the several first spacers 604 separate the first transverse column 603 into several independent sub-areas, and the pull cord 5 is wound around the first transverse column 603 in the several independent sub-areas.

It is further noted that, as shown in FIG. 7, the pull cord fixing seat 7 includes a main body 701 and a cover plate 702 located on the main body 701. Several (more than or equal to one) second spacers 705 are provided between the main body 701 and the cover plate 702, a through hole configured to allow the second transverse column 703 to pass through is provided in each second spacer 705, the several second spacers 705 separate the second transverse column 703 into several independent sub-areas, and the pull cord 5 is wound around the second transverse column 703 in the several independent sub-areas. It could be understood that, as shown in FIG. 8, the pull cord fixing seat 7 may not be provided with the second spacer.

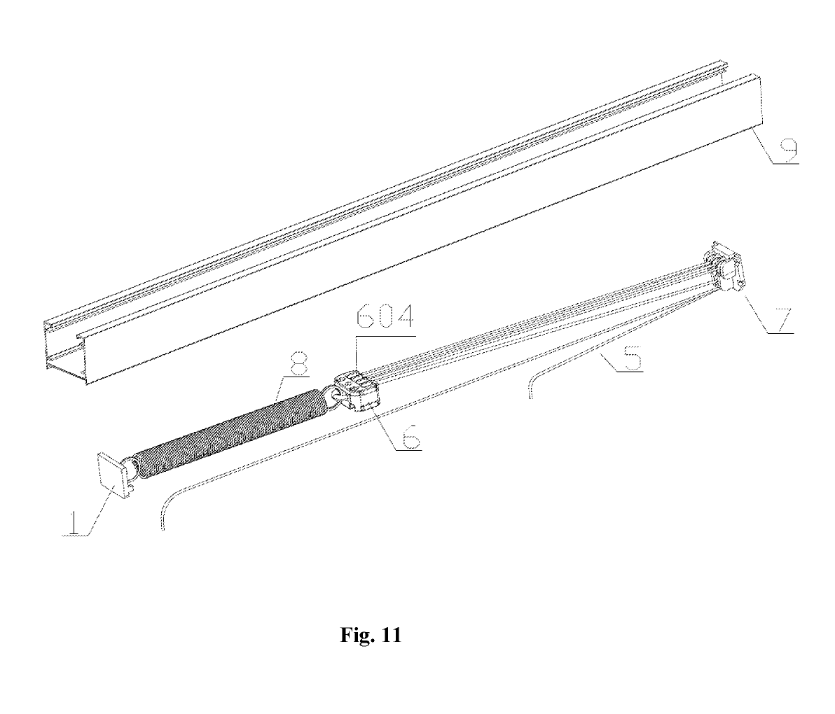

It is further noted that, in an embodiment as shown in FIGS. 11, 12 and 21, the movable part 6 may include a fitting portion, and the fitting portion is configured to be in direct contact with an inner wall of the guide rail 9. The fitting portion may be two side walls of the movable part 6, that is, two side walls of the movable parts 6 are respectively in direct contact with the inner wall at two sides of the guide rail 9. Therefore, the contact area between the movable part 6 and the guide rail 9 is relatively large, which increases the friction force between the movable part 6 and the guide rail 9; and when a user stops operating the operating the cordless window covering and wishes the window covering body to be fixed at a certain position, the cordless window covering is overall in a state of force equilibrium, therefore, the window covering body can stably stay at this position and the operation of the cordless window covering is stable and reliable.

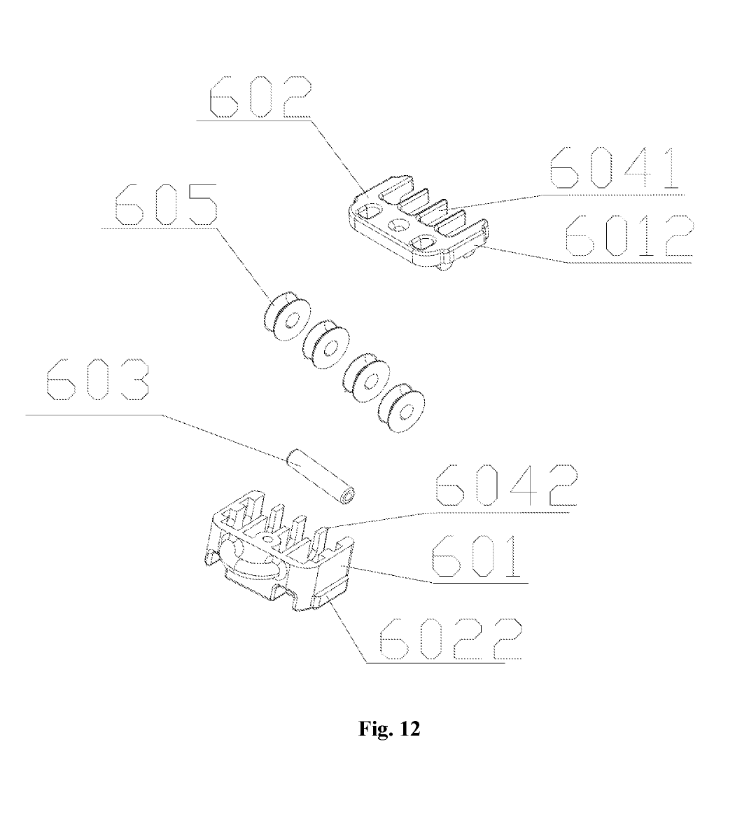

In another embodiment shown in FIG. 12, the movable part 6 includes a body 601, and a cover 602 located on the body 601 and detachably connected to the body 601. Three of the first spacers 604 are provided on the body 601 as shown in FIG. 12, and it can be appreciated by the person skilled in the art that, the number of the first spacers 604 is not limited to this, and can be selected according to practical requirements. Each of the first spacers 604 includes a first part 6041 located on the cover 602 and a second part 6042 located on the body 601. When the body 601 and the cover 602 are fixedly connected, the first part 6041 and the second part 6042 cooperate with each other to define a space, and this space is configured to accommodate the first transverse column 603. The first spacers 604 separate the first transverse column 603 into several independent sub-areas, and the pull cord 5 is wound around the first transverse column 603 in the several independent sub-areas.

Further, corresponding to the several independent sub-areas, the first transverse column 603 is provided with several pulleys 605 for winding the pull cord 5. By providing the pulleys 605, abrasion of the pull rod 5 can be reduced, which allows the pull cord 5 to run smoother.

Further, two side walls of the movable part 6 are each provided with a protruding portion extending outward from the respective side wall. The protruding portion is configured to be in direct contact with the guide rail 9, to allow the movable part 6 to move leftward and rightward stably in the guide rail 9.

Further, two transverse side walls of the body 601 of the movable part 6 are each provided with a protruding edge extending outward, and the protruding edge is the protruding portion. The two protruding edges of the body 601 may be provided at a bottom end of the body 601, and includes a first lower protruding edge 6012 and a second lower protruding edge 6022. Two transverse side walls of the cover 602 of the movable part 6 are each provided with a protruding edge extending outward, and the protruding edge is the protruding portion. The two protruding edges of the cover 602 may be provided at a top end of the cover 602, and includes a first upper protruding edge 6011 and a second upper protruding edge 6021.

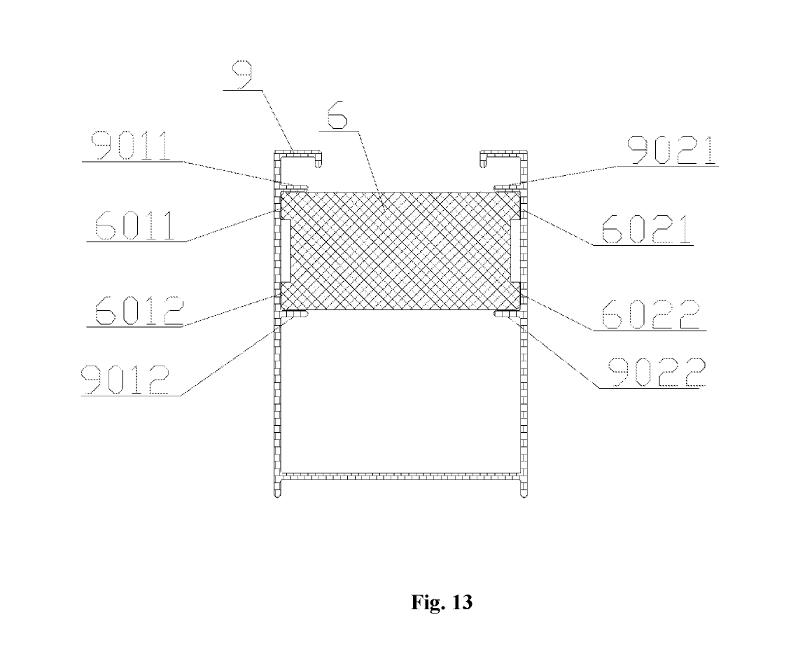

Referring to FIGS. 11 and 13, the guide rail 9 has a cavity for accommodating the movable part 6, the telescopic part 8 and the like. The cavity can be U-shaped, and can be in other shape which is not limited herein. Two side walls of the cavity are each provided with an upper guiding portion and a lower guiding portion, and the upper guiding portion and the lower guiding portion extend into the cavity from the respective side wall of the cavity, to form the sliding groove for allowing the movable part 6 to slide therein leftward and rightward.

As shown in FIG. 13, the inner wall at a first side of the cavity of the guide rail 9 is provided with a first upper guiding portion 9011 and a first lower guiding portion 9012 which are in parallel with each other, and the first upper guiding portion 9011 and the first lower guiding portion 9012 both extend from the inner wall at the first side into the cavity by a certain distance; the inner wall at a second side, opposite to the first side, of the cavity of the guide rail 9 is provided with a second upper guiding portion 9021 and a second lower guiding portion 9022 which are in parallel with each other, and the second upper guiding portion 9021 and the second lower guiding portion 9022 both extend from the inner wall at the second side into the cavity by a certain distance.

When the movable part 6 is installed in the sliding groove of the guide rail 9, in the up-down direction of FIG. 13, the movable part 6 is limited by the guiding portions of the guide rail 9; in the left-right direction of FIG. 13, the first upper protruding edge 6011 and the first lower protruding edge 6012 are in direct contact with the inner wall at the first side (that is the left side in FIG. 13) of the guide rail 9, the second upper protruding edge 6021 and the second lower protruding edge 6022 are in direct contact with the inner wall at the second side (that is the right side in FIG. 13) of the guide rail 9. Therefore, the contact area between the movable part 6 and the guide rail 9 is relatively large, which increases the friction force between the movable part 6 and the guide rail 9; and when a user stops operating the operating the cordless window covering and wishes the window covering body to be fixed at a certain position, the cordless window covering is overall in a state of force equilibrium, therefore, the window covering body can stably stay at this position and the operation of the cordless window covering is stable and reliable.

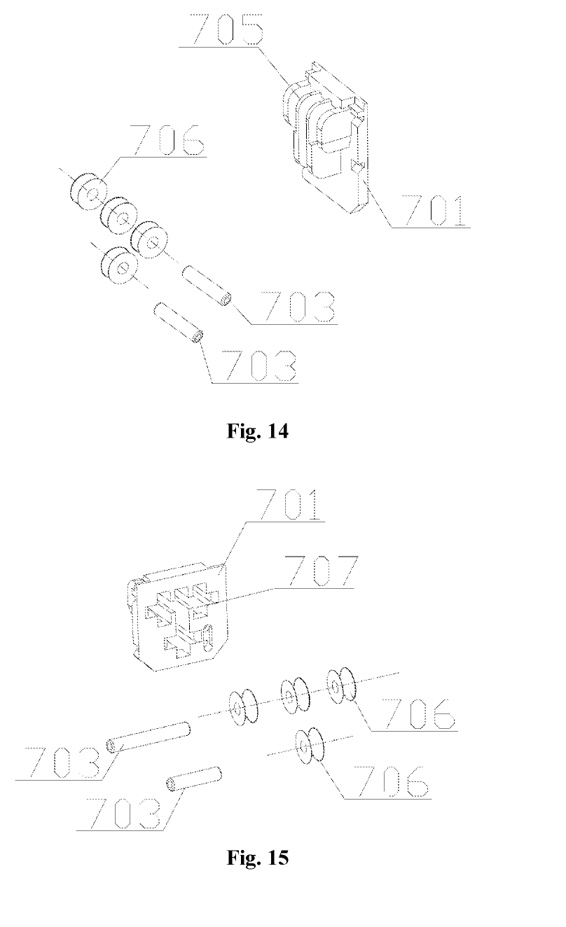

According to an embodiment, as shown in FIGS. 14 to 20, the pull cord fixing seat 7 includes a body 701, and at least one second spacer 705 is fixed at a first side of the body 701.

As shown in the drawings, the number of the spacers 705 is four, and it can be appreciated that, the number of the spacers 705 is not limited to this and can be selected according to practical requirements. Each of the spacers 705 has a groove for accommodating the second transverse column 703. The several second spacers 705 separate the second transverse column 703 into several independent sub-areas, and the pull cord 5 is wound around the second transverse column 703 in the several independent sub-areas.

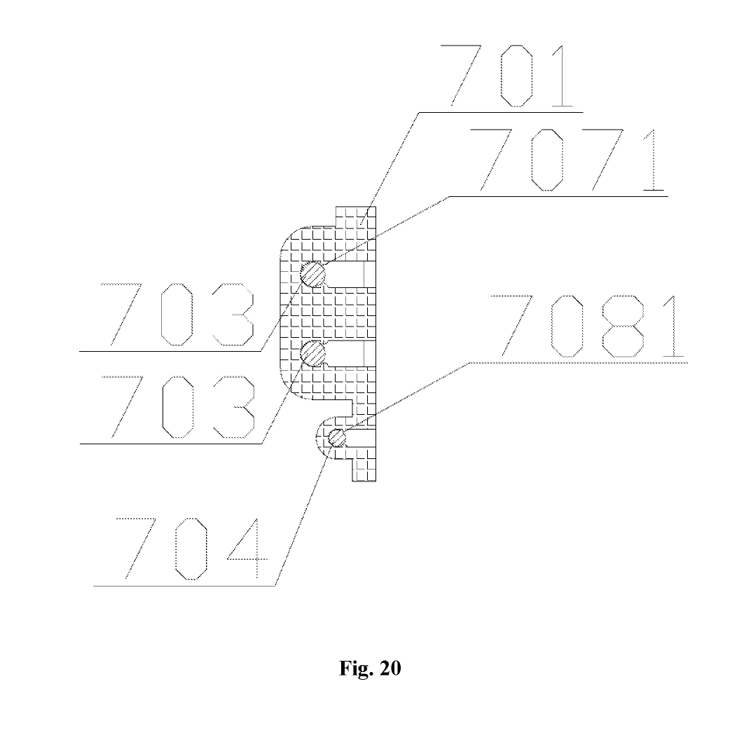

The first side of the pull cord fixing seat 7 is a side of the pull cord fixing seat 7 that is toward the movable part 6. A second side of the pull cord fixing seat 7, which is opposite to the first side of the pull cord fixing seat 7, is provided with a first opening 707, and the position of the first opening 707 is corresponding to the second spacer 705. The second transverse column 703 is installed into the body 701 through the first opening 707. As shown in FIG. 20, two side walls of the first opening 707 are each provided with a protrusion 7071; and when the second transverse column 703 is installed into the grooves of the second spacers 705, the protrusions 7071 are configured to prevent the second transverse column 703 from falling out.

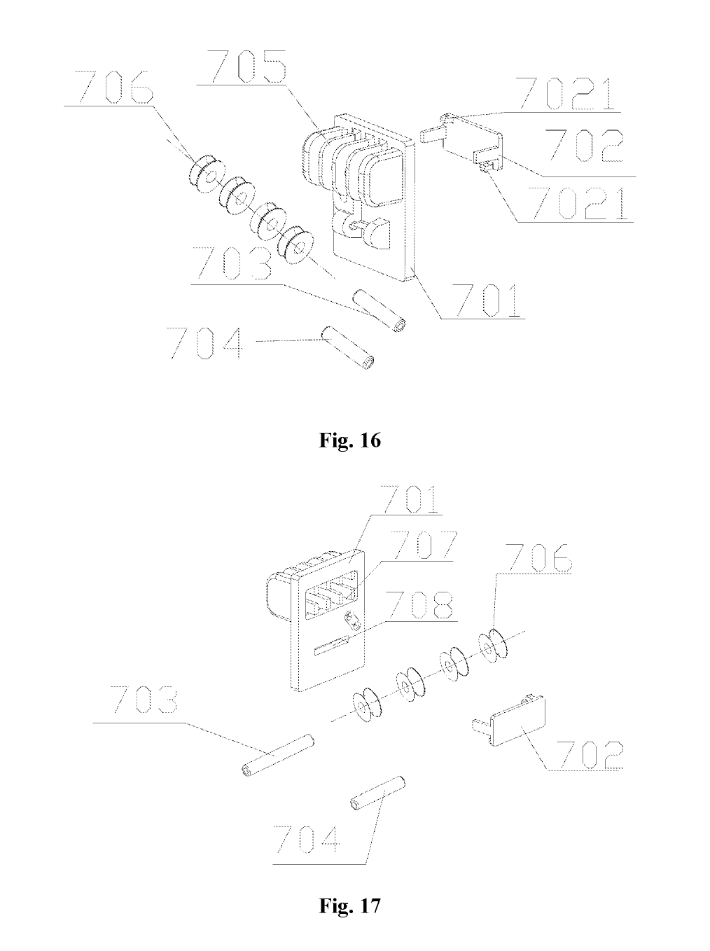

As shown in FIGS. 16 and 17, in this embodiment, the pull cord fixing seat 7 further includes a cover 702 detachably connected to the body 701. When the second transverse column 703 is installed into the body 701 through the first opening 707, the cover 702 is fixedly connected to the body 701, to close the first opening 707, thereby allowing the pull cord fixing seat 7 to have an artistic appearance. An upper end and a lower end of the cover 702 may be each provided with a fastener 7021 configured to fixedly connect the cover 702 to the body 701. It can be appreciated that, the position of the fastener 7021 is not limited to the position shown in the drawings, and can be selected according to practical requirements.

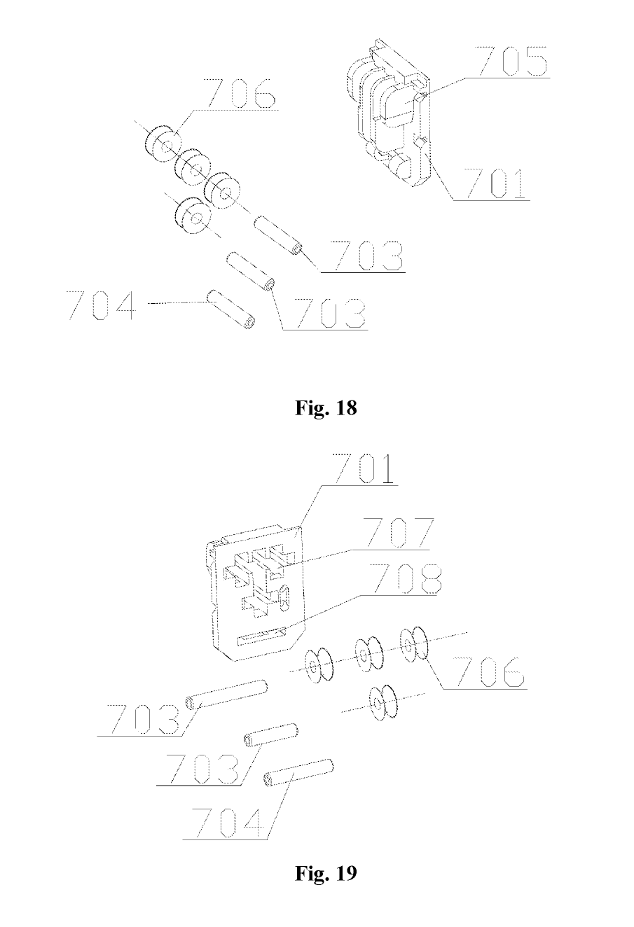

Further, as shown in FIGS. 18 to 20, a steering transverse column 704 is provided on the first side of the body 701 of the pull cord fixing seat 7. The steering transverse column 704 is located below the second transverse column 703, and the steering transverse column 704 and the position where the pull cord 5 is located after passing through the window covering body are substantially in one horizontal plane. The pull cord 5 passing through the window covering body first winds around the steering transverse column 704 and then winds around the first transverse column 603 and the second transverse column 703 back and forth, thereby avoiding the pull cord 5 from titling at a certain angle when the pull cord 5 directly winds around the first transverse column 603 and the second transverse column 703. After passing through the steering transverse column 704, the pull cord 5 winds around the first transverse column 603 and the second transverse column 703 back and forth in a substantially horizontal direction, thereby saving effort in pulling the pull cord 5.

The second side of the body 701 of the pull cord fixing seat 7 is further provided with a second opening 708, and the position of the second opening 708 is corresponding to the steering transverse column 704. The steering transverse column 704 can be installed into the body 701 via the second opening 708. As shown in FIG. 20, two side walls of the second opening 708 are each provided with a protrusion 7081; and when the steering transverse column 704 is installed into the groove of the body 701, the protrusions 7081 are configured to prevent the steering transverse column 704 from falling out.

Further, in the above embodiments shown in FIGS. 14 to 21, corresponding to the several independent sub-areas, the second transverse column 703 is provided with several pulleys 706 for winding the pull cord 5. By providing the pulleys 706, abrasion of the pull rod 5 can be reduced, which allows the pull cord 5 to run smoother.

It is to be noted that, in all of the above embodiments, each of the first transverse column 603 and the second transverse column 703 is arranged in a horizontal direction, and the first transverse column 603 and the second transverse column 703 may also be arranged in a vertical direction according to the heights of the guide rail 9, the movable part 6 and the pull cord fixing seat 7, and when the first transverse column 603 and the second transverse column 703 are arranged vertically, the spacers are arranged transversely.

In the specific use, each of the following is not limited specifically: the number of each of the first transverse column 603 and the second transverse column 703; transversely or vertically arranging the first transverse column 603 and the second transverse column 703; whether or not providing spacers in the first transverse column 603 and the second transverse column 703; and the number of spacers when the first transverse column 603 and the second transverse column 703 are provided with the spacers.

Referring to FIGS. 16 and 17, in this embodiment, the pull cord fixing seat 7 is provided with one of the second transverse column 703, and the spacers 705 are arranged in one row, and the second transverse column 703 passes through this row of spacers 705. The second spacers 705 separate the second transverse column 703 into several independent sub-areas, and the pull cord 5 is wound around the second transverse column 703 in the several independent sub-areas. By using the technical solution, the more the number of turns of the pull cord 5 winding around back and forth, the longer the length of the pull cord 5 on the window covering body, and the pull cords 5 in the several independent sub-areas will not interfere with each other, thereby avoiding kinking.

It can be appreciated by the person skilled in the art that, the second spacers 705 can also be arranged in more than one row, and the second transverse column 703 is accordingly provided. For example, as shown in FIGS. 14, 15, 18 and 19, the pull cord fixing seat 7 is provided with two of the second transverse column 703, and the spacers 705 are arranged in two rows, and the two second transverse columns 703 pass through the two rows of spacers 705 respectively. The two rows of second spacers 705 separate the second transverse column 703 into several independent sub-areas, and the pull cord 5 is wound around the second transverse column 703 in the several independent sub-areas. By using the technical solution, the more the number of turns of the pull cord 5 winding around back and forth, the longer the length of the pull cord 5 on the window covering body, and the pull cords 5 in the several independent sub-areas will not interfere with each other, thereby avoiding kinking.

It is to be noted that, in all of the above embodiments, the telescopic part 8 can be a spring, and also a rubber band; the telescopic part 8 may also be made of other stretchable materials, and will not be limited specifically herein.

In all of the above embodiments, the movable part 6, the telescopic part 8 and the pull cord fixing seat 7 can be located in the upper rail of the window covering body, and may also be located in the lower rail of the window covering body, and the specific position thereof is not limited.

With the above technical solution, the window covering body can move upward or downward, the cordless window covering is applicable to pleated blinds, organ shade, venetian blinds, Roman blinds, and etc.

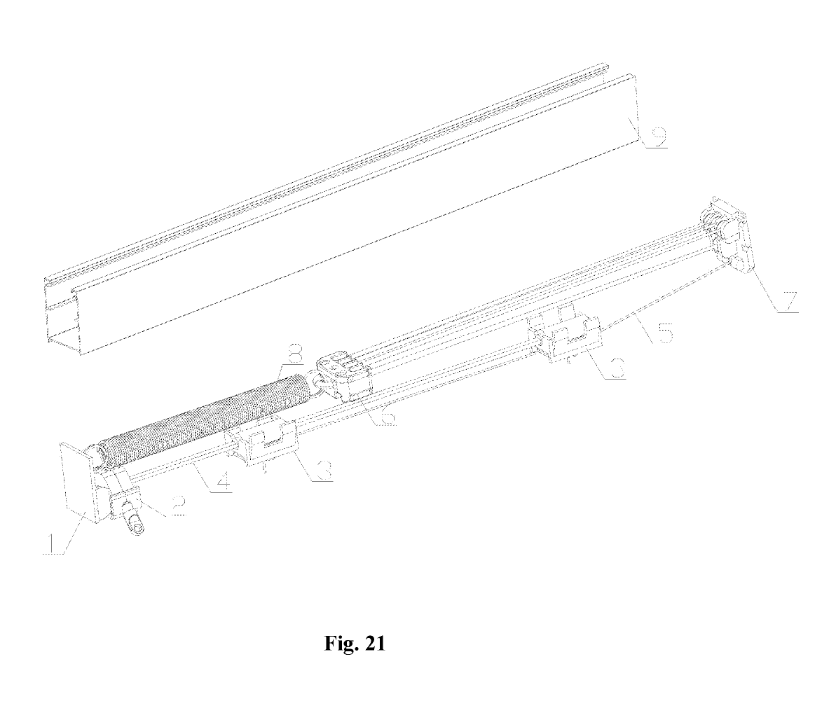

When the window covering body is a venetian blind, unlike the embodiment shown in FIG. 11, the cordless window covering may further include a venetian blind controller configured to control the window covering body to be reeled up or unfolded. As shown in FIG. 21, the venetian blind controller includes: a transmission shaft 4, a winder 10 sleeved on the transmission shaft 4, a controller 2 connected to an end of the transmission shaft 4 and configured to drive the transmission shaft 4 to rotate, a handle connected to the controller 2 and configured to drive the controller 2 to rotate, and a ladder tape passing through the window covering body (the window covering body 11 as shown in FIG. 1) and fixed on the winder 10. The handle is rotated by hand, to drive the controller 2 to rotate, thus the transmission shaft 4 can rotate counterclockwise or clockwise, the winder 10 sleeved on the transmission shaft 4 rotates counterclockwise or clockwise with the transmission shaft 4, and the winder 10 rolls the ladder tape passing through the window covering body (the window covering body 11 as shown in FIG. 1), thereby reeling up or unfolding the window covering body.

Optionally, the venetian blind controller may further include a winder mounting seat 3, the winder mounting seat 3 can be fixed on the guide rail 9, and the winder 10 is arranged on the winder mounting seat 3.

Optionally, a retaining groove configured for accommodating the winder 10 is provided on the winder mounting seat 3.

The present application has been described in detail above, for those skilled in the art, modifications to the specific embodiments and the application range could be made based on the ideal of the embodiments of the present application. In conclusion, the content of the specification should not be interpreted as limitation to the present application.

What is claimed is:

1. A cordless window covering, comprising a movable part, a telescopic part, a pull cord fixing seat, a pull cord and a guide rail; wherein,
the telescopic part has one end configured to be fixedly connected to a window, and another end configured to be connected to the movable part, and the movable part is movable leftward and rightward along with the telescopic part;
the pull cord fixing seat is configured to be fixedly connected to the window;
the guide rail has a cavity and a sliding groove is provided in the cavity; and
the movable part is provided with at least one first transverse column arranged transversely for winding the pull rod, the pull cord fixing seat is provided with at least one second transverse column arranged transversely for winding the pull rod, and the pull cord passing through a window covering body is configured to be fixed to the movable part or the pull cord fixing seat after winding around the first transverse column and the second transverse column; and
wherein, the movable part is provided with at least one first spacer, and the first transverse column is arranged on the at least one first spacer transversely, and the at least one first spacer separates the first transverse column along an axial direction of the first transverse column into a plurality of independent sub-areas for winding the pull cord; and
wherein, two side walls of the movable part are each provided with a fitting portion in direct contact with an inner wall of the guide rail, and the fitting portion of the movable part is configured to be guided by the sliding grove to allow the movable part to be movable leftward and rightward in the guide rail.

2. The cordless window covering according to claim 1, wherein the inner wall at a first side of the cavity of the guide rail is provided with a first upper guiding portion and a first lower guiding portion both extending from the inner wall at the first side into the cavity; the inner wall at a second side, opposite to the first side, of the cavity of the guide rail is provided with a second upper guiding portion and a second lower guiding portion both extending from the inner wall at the second side into the cavity; and the sliding groove is formed by the first upper guiding portion, the first lower guiding portion, the second upper guiding portion and the second lower guiding portion; and
the fitting portion comprises a first upper protruding portion and a first lower protruding portion both extending outward from a first side wall of the movable part, and a second upper protruding portion and a second lower protruding portion both extending outward from a second side wall of the movable part, and the second side wall of the movable part is opposite to the first side wall of the movable part; and
wherein, the first upper protruding portion and the first lower protruding portion are in direct contact with the inner wall at the first side of the cavity, the second upper protruding portion and the second lower protruding portion are in direct contact with the inner wall at the second side of the cavity, to allow the movable part to be guided by the first upper guiding portion, the first lower guiding portion, the second upper guiding portion and the second lower guiding portion to move leftward and rightward along the guide rail.

3. The cordless window covering according to claim 2, wherein the movable part comprises a body and a cover detachably connected to the body; the first upper protruding portion and the second upper protruding portion are respectively two protruding edges extending outward from two transverse side walls of the cover, and the first lower protruding portion and the second lower protruding portion are respectively two protruding edges extending outward from two transverse side walls of the body.

4. The cordless window covering according to claim 3, wherein each of the at least one first spacer has a first part located at the cover and a second part located at the body; and when the body and the cover are assembled, the first part and the second part cooperate with each other to define a space for accommodating the first transverse column.

5. The cordless window covering according to claim 1, wherein the first transverse column is provided with a plurality of pulleys for winding the pull cord located in the plurality of independent sub-areas of the first transverse column respectively.

6. The cordless window covering according to claim 1, wherein the inner wall at a first side of the cavity of the guide rail is provided with a first upper guiding portion and a first lower guiding portion both extending from the inner wall at the first side into the cavity; the inner wall at a second side, opposite to the first side, of the cavity of the guide rail is provided with a second upper guiding portion and a second lower guiding portion both extending from the inner wall at the second side into the cavity; and the sliding groove is formed by the first upper guiding portion, the first lower guiding portion, the second upper guiding portion and the second lower guiding portion; and
the fitting portion comprises a first side wall of the movable part, and a second side wall of the movable part which is opposite to the first side wall of the movable part; and
wherein, the first side wall is in direct contact with the inner wall at the first side of the cavity, the second side wall is in direct contact with the inner wall at the second side of the cavity, to allow the movable part to be guided by the first upper guiding portion, the first lower guiding portion, the second upper guiding portion and the second lower guiding portion to move leftward and rightward along the guide rail.

7. The cordless window covering according to claim 1, wherein the pull cord fixing seat is provided with at least one second spacer, and the second transverse column is arranged on the at least one spacer transversely, and the at least one second spacer separates the second transverse column along an axial direction of the second transverse column into a plurality of independent sub-areas for winding the pull cord.

8. The cordless window covering according to claim 7, wherein the pull cord fixing seat has a body, and the at least one second spacer is fixedly provided at a first side of the body; a first opening is provided at a second side of the body, which is opposite to the first side of the body, to allow the at least one second transverse column to be installed via the first opening; a side wall of the first opening has a protrusion; and in a case that the at least one second transverse column is installed in place, the protrusion is configured to retain the at least one second transverse column.

9. The cordless window covering according to claim 8, wherein the pull cord fixing seat further has a cover detachably connected to the body; and in a case that the at least one second transverse column is installed in place, the cover is fixedly connected to the body, to close the first opening.

10. The cordless window covering according to claim 8, wherein a steering transverse column is further provided on the pull cord fixing seat, the pull cord passing through the window covering body is configured to wind around the first transverse column and the second transverse column after winding around the steering transverse column.

11. The cordless window covering according to claim 10, wherein the second side of the body of the pull cord fixing seat further has a second opening, to allow the steering transverse column to be installed via the second opening; a side wall of the second opening has a protrusion; and in a case that the steering transverse column is installed in place, the protrusion is configured to retain the steering transverse column.

12. The cordless window covering according to claim 2, wherein the pull cord fixing seat is provided with at least one second spacer, and the second transverse column is arranged on the at least one spacer transversely, and the at least one second spacer separates the second transverse column along an axial direction of the second transverse column into a plurality of independent sub-areas for winding the pull cord.

13. The cordless window covering according to claim 12, wherein the pull cord fixing seat has a body, and the at least one second spacer is fixedly provided at a first side of the body of the pull cord fixing seat; a first opening is provided at a second side of the body of the pull cord fixing seat, which is opposite to the first side of the body of the pull cord fixing seat, to allow the at least one second transverse column to be installed via the first opening; a side wall of the first opening has a protrusion; and in a case that the at least one second transverse column is installed in place, the protrusion is configured to retain the at least one second transverse column.

14. The cordless window covering according to claim 7, wherein a plurality of second spacers are provided on the pull cord fixing seat, and the plurality of second spacers are arranged in at least one row and are in parallel with each other in each row, and each row of the second spacers has one of the second transverse column passing through the second spacers in this row.

15. The cordless window covering according to claim 7, wherein the second transverse column is provided with a plurality of pulleys for winding the pull cord located in the plurality of independent sub-areas of the second transverse column respectively.

16. The cordless window covering according to claim 1, further comprising a telescopic part fixing seat, wherein the telescopic part fixing seat is fixed on the guide rail, and an end of the telescopic part is mounted on the telescopic part fixing seat.

17. The cordless window covering according to claim 1, wherein the pull cord fixing seat is fixed on the guide rail.

18. The cordless window covering according to claim 1, further comprising a transmission shaft, a winder configured to be sleeved on the transmission shaft, a controller configured to be connected to an end of the transmission shaft and drive the transmission shaft to rotate, a handle configured to be connected to the controller and drive the controller to rotate, and a ladder tape configured to pass through the window covering body and to be fixed on the winder.

19. The cordless window covering according to claim 18, further comprising a winder mounting seat, wherein the winder mounting seat is fixed on the guide rail, and the winder is arranged on the winder mounting seat.

20. The cordless window covering according to claim 19, wherein a retaining groove is provided on the winder mounting seat and is configured for accommodating the winder.
